(19) United States
(12) Patent Application Publication
(10) Pub. No.: US 2014/0023913 A1
(43) Pub. Date: Jan. 23, 2014

(54) PRISMATIC SECONDARY BATTERY

(71) Applicants: Yoshinori Yokoyama, Kasai-shi (JP); Takayuki Hattori, Kasai-shi (JP); Eiji Okutani, Kasai-shi (JP); Yasuhiro Yamauchi, Kasai-shi (JP)

(72) Inventors: Yoshinori Yokoyama, Kasai-shi (JP); Takayuki Hattori, Kasai-shi (JP); Eiji Okutani, Kasai-shi (JP); Yasuhiro Yamauchi, Kasai-shi (JP)

(73) Assignee: SANYO ELECTRIC CO., LTD., Osaka (JP)

(21) Appl. No.: 13/550,866

(22) Filed: Jul. 17, 2012

(51) Int. Cl. H01M 2/06; H01M 2/30; H01M 2/02

(52) U.S. Cl. 429/179

(57) ABSTRACT

In a prismatic secondary battery, a negative electrode terminal is fixed to a sealing plate in an insulated manner through through-holes formed in the sealing plate, first and second insulating members, and a collector. The collector includes a flat attachment part with the through-hole and a main body bent from an end of the flat attachment part and electrically connected to an electrode assembly. The second insulating member includes a depression having peripheral ribs on an opposite face to the sealing plate. At least one of the peripheral ribs along the short sides thereof has at least one of a width and height larger than that of the peripheral rib along the long sides thereof. The flat attachment part of the collector is fitted to the depression.

### TECHNICAL FIELD

The present invention relates to a prismatic secondary battery including a sealing plate equipped with a collector that can be precisely bent.

### BACKGROUND ART

Alkaline secondary batteries typified by nickel-hydrogen batteries and nonaqueous electrolyte secondary batteries typified by lithium ion batteries are widely used as power supplies for driving portable electronic equipment such as cell phones including smartphones, portable computers, PDAs, and portable music players. In addition, alkaline secondary batteries and nonaqueous electrolyte secondary batteries are also widely used for power supplies for driving electric vehicles (EVs) and hybrid electric vehicles (HEVs, PHEVs), and used in stationary storage battery systems for suppressing the variation in output power of photovoltaic generation or wind power generation, for example, and for peak shifts in system power in order to store electric power during the nighttime and to use the electric power during daytime.

A single secondary battery has a low electromotive force, and even a lithium ion secondary battery that is considered to have a comparatively high electromotive force has an electromotive force of about 4 V. For using such a battery for vehicles such as EVs, HEVs, and PHEVs that need high capacity and high output characteristics, each battery is upsized, and a number of batteries are connected in series or parallel to form a battery pack as shown in US 2010/316906 (A1) and US 2008/299453 (A1), for example. To address this, in these applications, prismatic secondary batteries are typically used from the viewpoint of space efficiency.

Meanwhile, batteries used for EVs, HEVs, and PHEVs are generally nickel-hydrogen secondary batteries or lithium ion secondary batteries. However, there is an increasing demand for not only environmental friendliness, but also basic performance as a vehicle, in other words, superior driving performance. Therefore, it is necessary not only to enlarge the battery capacity, but also to increase the battery output that largely affects the acceleration and hill-climbing performance of a vehicle. However, with an electrical discharge at a high output, a large current flows in the battery, and as a result there is a large increase in heat due to contact resistance between the substrate of an electrode assembly and the collector. Thus, batteries for EVs, HEVs, and PHEVs are required not only to have a large size and large capacity, but also to be able to handle a large current. Accordingly, in order to prevent electricity loss inside the battery and to reduce heat emission, various improvements have been carried out with regard to lowering the internal resistance by preventing welding faults between the substrate of an electrode and the collector.

Examples of a method for electrically connecting a substrate exposed portion of an electrode sheet in an electrode assembly as an electric power generating element to a collector for electric current collection include mechanical crimping and welding. Welding is suitable as an electric current collection method for batteries of which high output is required because the connection readily achieves low resistance and is unlikely to be changed over time. Such resistance welding between a substrate exposed portion of an electrode sheet and a collector in a prismatic secondary battery is carried out as follows.

For example, in nonaqueous electrolyte secondary batteries disclosed in U.S. Pat. No. 7,943,253 (B2) and US 2010-221602 (A1), as shown in FIG. 7, in a flat wound electrode assembly 50 in which a positive electrode sheet and a negative electrode sheet are wound many times while being insulated from each other with a separator interposed therebetween, for example, a negative electrode collector 52 made of copper or a copper alloy is disposed on one face of a bundled negative electrode substrate exposed portion 51 made of copper or a copper alloy. Similarly, a negative electrode collector receiving member 53 made of copper or a copper alloy is disposed on the other face. Then, resistance-welding electrodes 54 and 55 are brought into contact with the negative electrode collector 52 and the negative electrode collector receiving member 53, respectively, and resistance welding is performed.

As a result, a part of the negative electrode substrate exposed portion 51 between a pair of the resistance-welding electrodes 54 and 55 is melted to appropriately form a nugget 56, thereby achieving good electrical connection between the negative electrode substrate exposed portion 51 and the negative electrode collector 52, and between the negative electrode substrate exposed portion 51 and the negative electrode collector receiving member 53. A positive electrode substrate exposed portion, a positive electrode collector, and a positive electrode collector receiving member (not shown in the drawings) have substantially the same structures as those of the negative electrode substrate exposed portion 51, the negative electrode collector 52, and the negative electrode collector receiving member 53, respectively, except that the positive electrode substrate exposed portion, the positive electrode collector, and the positive electrode collector receiving member are made of aluminum or an aluminum alloy.

In prismatic secondary batteries for EVs, HEVs, and PHEVs, a terminal that is provided on a sealing plate and is for putting out current from an electrode assembly is connected to a substrate exposed portion of the electrode assembly with a collector interposed therebetween. The collector is commonly supplied as a flat plate. Thus, the collector is attached to the sealing plate with an insulating member interposed therebetween, then is bent, and is welded to the substrate exposed portion of the electrode assembly. However, when the collector is not bent at a precise angle at the attachment position to the sealing plate, the contact between the collector and the substrate exposed portion of the electrode assembly is insufficient, thereby readily causing a defect such as spattering during welding. In addition, this makes it difficult to insert the electrode assembly into an outer body due to interference.

### SUMMARY

An advantage of some aspects of the invention is to provide a prismatic secondary battery in which the structure of an insulating member provided on a sealing plate is improved, thereby readily bending a collector at a precise angle at an attachment position to the sealing plate, and consequently the collector is securely welded to a substrate exposed portion of an electrode assembly.

According to an aspect of the invention, a prismatic secondary battery includes a prismatic hollow outer body having a mouth portion and a bottom, a sealing plate sealing up the mouth portion, an electrode assembly stored in the prismatic hollow outer body, a collector electrically connected to the electrode assembly, and a terminal electrically connected to the collector. A first insulating member is disposed on one face of the sealing plate, a second insulating member is disposed on the other face of the sealing plate, and the sealing plate, the first insulating member, the second insulating member, and the collector all have through-holes, and the terminal is fixed to the sealing plate through the through-holes formed in the sealing plate, the first insulating member, the second insulating member, and the collector in a manner electrically insulated from the sealing plate. In the prismatic secondary battery, the collector includes a flat attachment part with an opening serving as the through-hole and a main body bent from an end of the flat attachment part and electrically connected to the electrode assembly, the second insulating member is made from a plate member, the plate member includes a depression having a peripheral rib on an opposite face to the sealing plate, the peripheral rib includes two sides along short sides of the sealing plate, at least one side closer to the bending part of the collector than the other side along the short sides having at least one of a width and height larger than that of the other two sides along the long sides of the sealing plate, the flat attachment part of the collector is fitted to the depression.

In the prismatic secondary battery of the invention, the flat attachment part of the collector is fitted to the depression formed in the second insulating member. The collector is commonly supplied as a flat plate. The collector is fixed to the sealing plate together with the second insulating member and then is bent approximately 90 degrees at the boundary with the flat attachment part of the collector (bending standard position). In the peripheral rib formed on the second insulating member in the prismatic secondary battery of the invention, at least one of the two sides along the short sides of the sealing plate has at least one of a width and height larger than that of the other two sides along the long sides of the sealing plate. Hence, the main body of the collector is readily bent precisely at the bending standard position, thereby achieving a good positional relation between the collector and a stacked substrate exposed portion of the electrode assembly. Therefore, in the prismatic secondary battery of the invention, the collector is securely welded to the substrate exposed portion of the electrode assembly. In addition, the collector can be bent as designed and consequently the electrode assembly can be easily inserted into the prismatic hollow outer body. The second insulating member including the peripheral rib of which both two sides along the short sides of the sealing plate have a width and height larger than those of the other two sides along the long sides of the sealing plate can better provide the above-described advantages. It is preferable that the peripheral rib formed on the second insulating member is provided with a cutout, and is preferable that the collector is passed through the cutout of the peripheral rib formed on the second insulating member in the state before and after the collector is bent. The collector may be not required to be passed through the cutout of the peripheral rib in the state after the collector is bent. If the collector is passed through the cutout of the peripheral rib in the state after the collector is bent, movement of the collector can be decreased.

In the prismatic secondary battery of the aspect, the collector may have a pair of main bodies formed from both ends of the flat attachment part in opposite directions to each other.

When the collector has the pair of main bodies formed from both ends of the flat attachment part in opposite directions to each other as above, electric current can be collected from both outermost faces of the stacked substrate of the electrode assembly, thereby reducing the internal resistance. As a result, a prismatic secondary battery suitable for an application required to have a large size and large capacity can be obtained.

In the prismatic secondary battery of the aspect, it is preferable that the terminal have a flange in a site of the first insulating member and also have a crimping part in a site of the second insulating member, the flange be disposed to be in contact with the first insulating member, and the crimping part connect the terminal to the flat attachment part of the collector and integrally fix the sealing plate, the first insulating member, the second insulating member, and the collector.

Such a structure can ensure the insulation and the air tightness between the terminal and the sealing plate, and can firmly integrate the sealing plate, the first insulating member, the second insulating member, the collector, and the terminal. Such a structure can also reduce the contact resistance between the flat attachment part of the collector and the terminal. Therefore, the prismatic secondary battery of the invention is best suited for use in a highly vibrating environment, such as in EVs, PHEVs, and HEVs.

In the prismatic secondary battery of the aspect, it is preferable that the peripheral rib have a partial cutout in at least one side along the long sides of the sealing plate.

Such a structure can suppress deformation of the peripheral rib by the main body of the collector when the collector supplied as a flat plate is fixed to the sealing plate together with the second insulating member. Therefore, the prismatic secondary battery of the invention provides a prismatic secondary battery that better provides the above-described advantages.

In the prismatic secondary battery of the aspect, it is preferable that the collector have a cutout at the boundary between the flat attachment part and the main body where the collector has a smaller width than the width of the main body.

Such a structure enables easy bending of the collector at the boundary between the flat attachment part and the main body, thereby more precisely bending the main body of the collector as designed.

In the prismatic secondary battery of the aspect, the electrode assembly may include two ends opposite to each other, one end having a stacked substrate exposed portion of an electrode, and the other end having a stacked substrate exposed portion of a counter electrode, the collector may have the pair of main bodies formed from both ends of the flat attachment part in opposite directions to each other, and the main bodies of the collector may be connected to both outer faces of at least one of the substrate exposed portions.

With such a structure, electric current can be collected from both outermost faces of the substrate exposed portions through the collector, thereby reducing the internal resistance. As a result, a prismatic secondary battery suitable for an application required to have a large size and large capacity can be obtained.

It is preferable that the main bodies of the collector be connected to the substrate exposed portion(s) by welding, and that the main bodies of the collector include a bent rib standing therefrom along a side facing the electrode assembly near the welding part.

The collector having the rib as above can shield particles spattered during welding by the rib. The rib can also dissipate heat generated during welding.

In the prismatic secondary battery of the aspect, at least one of the substrate exposed portions may be divided into two portions, an intermediate member having at least one conductive member may be disposed between the portions, the main body of the collector in a site of the bisectional substrate exposed portion may be disposed on an outermost face of the bisectional substrate exposed portion, and the main body of the collector may be resistance-welded to the substrate exposed portion.

Such a structure reduces each stacking number of the bisectional substrate exposed portions to enable good resistance welding at the interior of each substrate exposed portion. Moreover, such an intermediate member leads the current during resistance welding to flow in the following order: one collector, one part of the bisectionally-divided substrate exposed portion, the conductive member, the other part of the bisectionally-divided substrate exposed portion, and the other collector. Thus, a single process of resistance welding can simultaneously connect two sites between the substrate exposed portion and the corresponding collector. In addition, a large weld mark is formed on the collector side, consequently increasing the welding strength between the collector and the corresponding substrate exposed portion as well as reducing electric resistance, thereby suppressing the power reduction during high current discharging.

In the prismatic secondary battery of the aspect, the electrode assembly may include two ends opposite to each other, one end having a stacked substrate exposed portion of an electrode, and the other end having a stacked substrate exposed portion of a counter electrode, the main body of the collector may be connected to one outermost face of at least one of the substrate exposed portions, and a collector receiving member may be connected to the other outermost face of at least one of the substrate exposed portions. In the aspect, it is preferable that the main body of the collector and the collector receiving member be connected to the substrate exposed portions by welding, and that both the main body of the collector and the collector receiving member include a bent rib standing therefrom along a side facing the electrode assembly near the welding part. Furthermore, at least one of the substrate exposed portions may be divided into two portions, an intermediate member having at least one conductive member may be disposed between the portions, both the main body of the collector in a site of the bisectional substrate exposed portion and the collector receiving member may be disposed on an outermost face of the bisectional substrate exposed portion, and both the main body of the collector and the collector receiving member may be resistance-welded to the substrate exposed portion.

With the prismatic secondary battery of the invention, even when the collector is used on one face of the substrate exposed portions, the use of the collector receiving member in combination enables the prismatic secondary battery to provide substantially the same advantages as the case using the same collectors on both outermost faces of the substrate exposed portions.

### BRIEF DESCRIPTION OF THE DRAWINGS

The invention will be described with reference to the accompanying drawings, wherein like numbers reference like elements.

FIG. 1A is a sectional view of a main part of a prismatic nonaqueous electrolyte secondary battery of an embodiment, and FIG. 1B is a sectional view taken along the line IB-IB in FIG. 1A.

FIG. 2 is a plan view from the back face of a sealing plate attached with a flat attachment part of a collector of the embodiment.

FIG. 3 is an enlarged partial sectional view of a part III in FIG. 2.

FIG. 4 is a partial sectional front view of the sealing plate in FIG. 2 with the collector bent.

FIG. 5 is an enlarged view of a part V in FIG. 4.

FIG. 6 is a plan view from the back face of the sealing plate attached with a flat attachment part of a collector of a modification.

FIG. 7 is a sectional view showing resistance welding of collectors in a related-art prismatic secondary battery.

### DESCRIPTION OF EXEMPLARY EMBODIMENTS

Embodiments of the invention will now be described in detail with reference to drawings. However, each embodiment described below is intended to exemplify the technical spirit of the invention, the invention is not intended to be limited to the embodiments, and the invention may equally be applied to various modified cases without departing from the technical spirit described in the claims. The prismatic secondary battery of the invention can be equally applied to a case using a flat wound electrode assembly that is obtained by winding a positive electrode sheet and a negative electrode sheet with a separator interposed therebetween and to a case using a flat stacked electrode assembly that is obtained by stacking positive electrode sheets and negative electrode sheets with separators interposed therebetween. However, the flat wound electrode assembly will be described below as a typical example.

### Embodiment

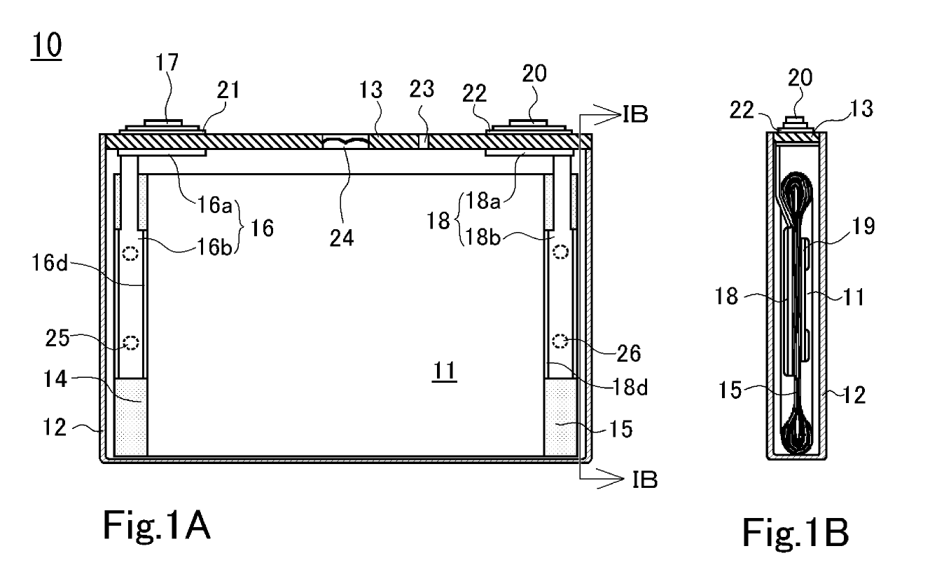

First, the specific structure of a prismatic nonaqueous electrolyte secondary battery 10 common to the embodiment and a modification will be described with reference to FIG. 1. FIG. 1A is a sectional view of a main part of a prismatic nonaqueous electrolyte secondary battery of the embodiment, and FIG. 1B is a sectional view taken along the line IB-IB in FIG. 1A.

The prismatic nonaqueous electrolyte secondary battery 10 includes a flat wound electrode assembly 11 in which a positive electrode sheet and a negative electrode sheet are wound with a separator interposed therebetween (not shown in the drawings), the flat wound electrode assembly 11 is stored in a prismatic hollow outer body 12, and the prismatic hollow outer body 12 is sealed with a sealing plate 13. The flat wound electrode assembly 11 includes a negative electrode substrate exposed portion 14 and a positive electrode substrate exposed portion 15 without a negative electrode active material mixture coating and a positive electrode active material mixture coating, respectively, on respective ends in the winding axis direction. The negative electrode substrate exposed portion 14 is connected to a negative electrode terminal 17 with a negative electrode collector 16 interposed therebetween. The positive electrode substrate exposed portion 15 is connected to a positive electrode terminal 20 with a positive electrode collector 18 interposed therebetween. The negative electrode terminal 17 and the positive electrode terminal 20 are fixed to the sealing plate 13 with insulating members 21 and 22, respectively, interposed therebetween. The prismatic nonaqueous electrolyte secondary battery 10 is produced by inserting the flat wound electrode assembly 11 in the prismatic hollow outer body 12, then laser-welding the sealing plate 13 to a mouth edge of the prismatic hollow outer body 12, pouring a nonaqueous electrolytic solution from an electrolyte pour hole 23, and sealing the electrolyte pour hole. The sealing plate 13 is also equipped with a gas release valve 24 as a safe means for releasing gas when the pressure in the battery is increased.

Next, the specific method for producing the flat wound electrode assembly 11 of the embodiment will be described. The positive electrode sheet was prepared as follows. A positive electrode active material mixture containing a positive electrode active material such as lithium cobalt oxide (LiCoO₂) was evenly applied onto both faces of a rectangular aluminum foil having a thickness of 15 m as a positive electrode substrate to form a positive electrode active material mixture layer while the positive electrode active material mixture was not applied onto one edge in a short side direction of the positive electrode substrate to form a positive electrode substrate exposed portion having a predetermined width. The negative electrode sheet was prepared as follows. A negative electrode active material mixture containing natural graphite powder as a negative electrode active material was evenly applied onto both faces of a rectangular copper foil having a thickness of 8 m as a negative electrode substrate to form a negative electrode active material mixture layer while the negative electrode active material mixture was not applied onto one edge in a short side direction of the negative electrode substrate to form a negative electrode substrate exposed portion having a predetermined width.

The positive electrode sheet and the negative electrode sheet obtained as above were stacked with a microporous polyethylene separator interposed therebetween so as to displace both the positive electrode substrate exposed portion and the negative electrode substrate exposed portion from the corresponding counter electrode active material mixture layer, and the whole was wound to form the flat wound electrode assembly 11 that included one end with the negative electrode substrate exposed portion 14 stacking a plurality of the copper foils and the other end with the positive electrode substrate exposed portion 15 stacking a plurality of the aluminum foils and that was used in the embodiment.

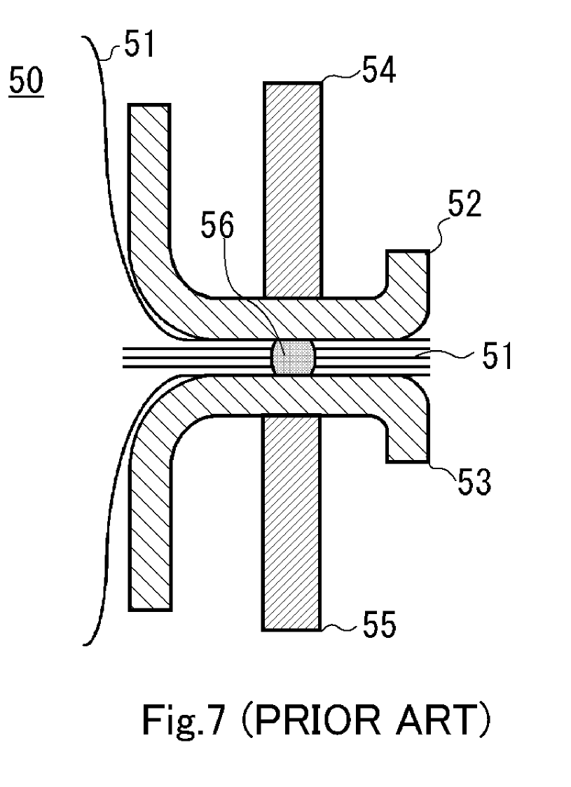

A copper negative electrode collector 16 and a copper negative electrode collector receiving member (not shown in the drawings) were attached to the negative electrode substrate exposed portion 14 of the flat wound electrode assembly 11 prepared as above by resistance welding. An aluminum positive electrode collector 18 and an aluminum positive electrode collector receiving member 19 were attached to the positive electrode substrate exposed portion 15 by resistance welding. The resistance-welding method will not be described in detail because the welding is not different from that for the related-art example shown in FIG. 7. FIG. 1A shows weld marks 25 formed on the negative electrode collector 16 by resistance welding and resistance weld marks 26 formed on the surface of the positive electrode collector 18.

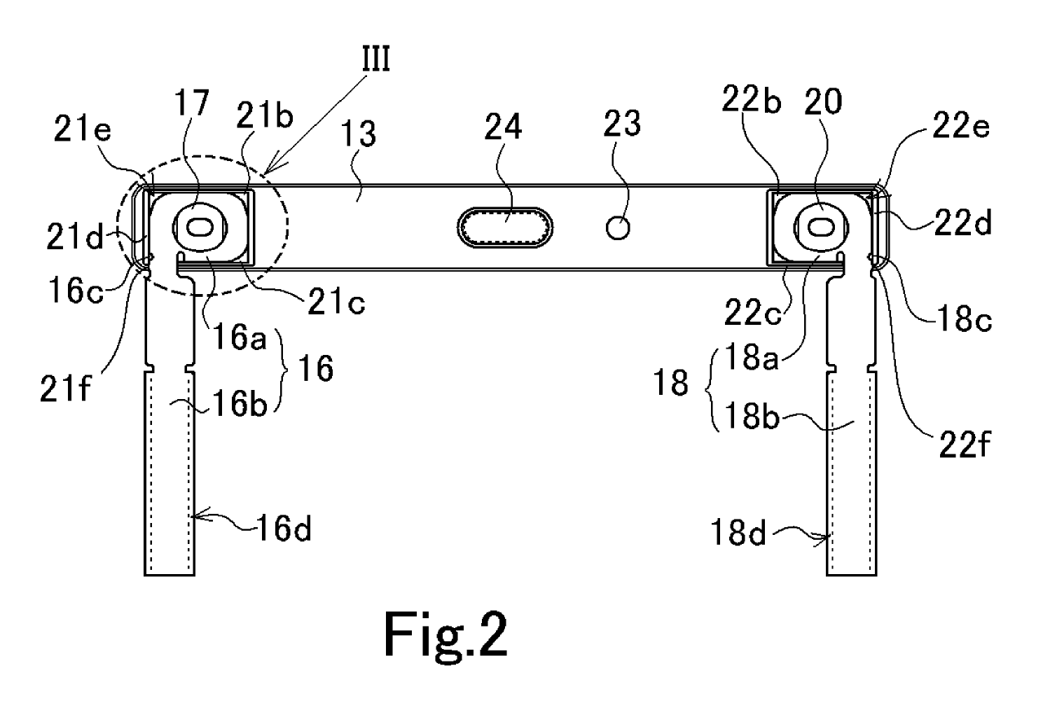

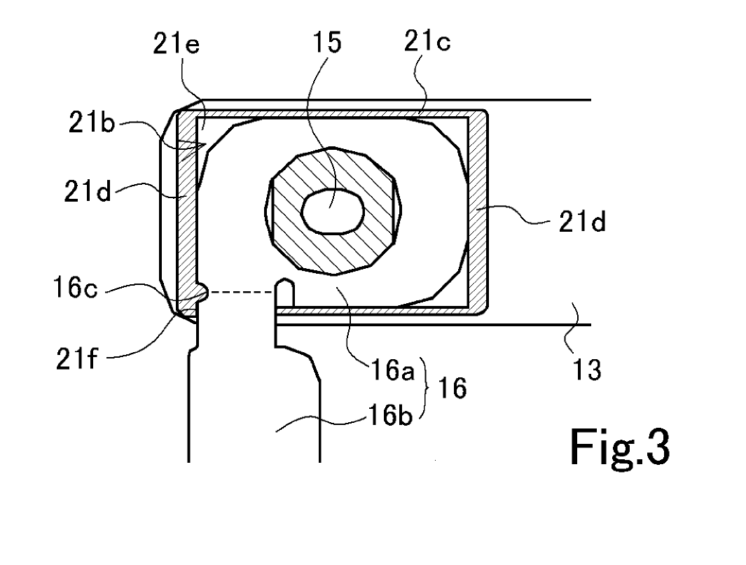

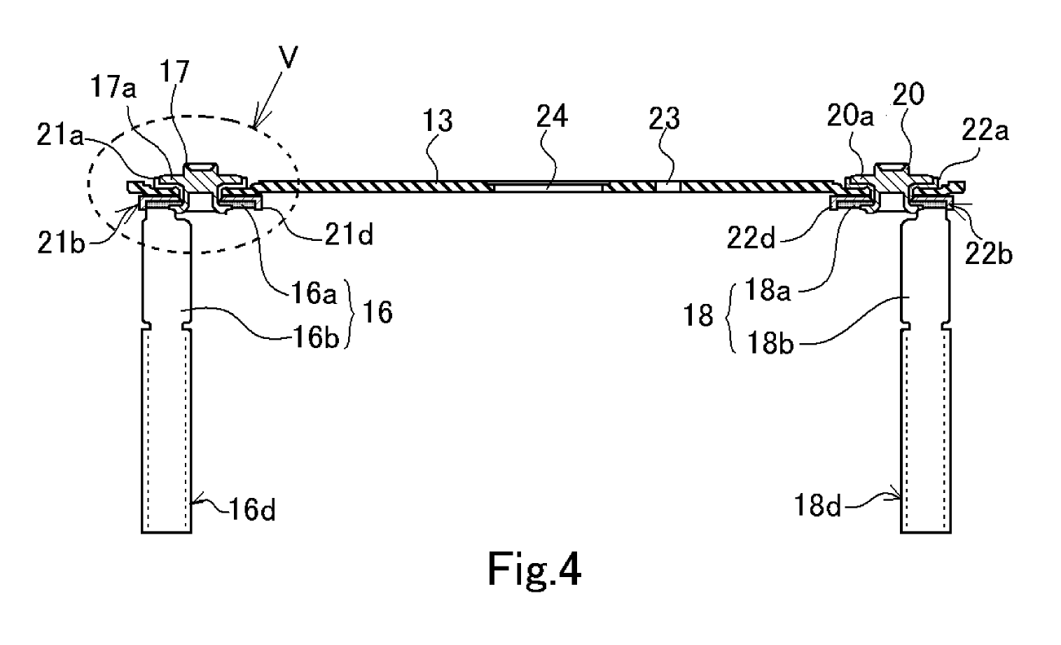

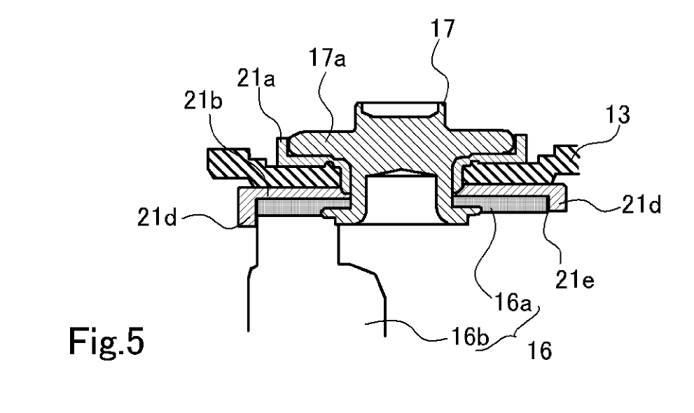

Next, each attachment state of the negative electrode collector 16 and the positive electrode collector 18 to the sealing plate will be described with reference to FIG. 2 to FIG. 5. FIG. 2 is a plan view from the back face of the sealing plate attached with a flat attachment part of a collector of the embodiment. FIG. 3 is an enlarged partial sectional view of a part III in FIG. 2. FIG. 4 is a partial sectional front view of the sealing plate in FIG. 2 with the collector bent. FIG. 5 is an enlarged view of a part V in FIG. 4.

With respect to one mouth formed in the sealing plate 13, a first insulating member 21a composed of a gasket is disposed on a front face of the sealing plate 13, a second insulating member 21b is disposed on a back face of the sealing plate 13, and the negative electrode terminal 17 is inserted through the first insulating member 21a and the second insulating member 21b. The negative electrode terminal 17 has a flange 17a and is disposed so that the bottom face of the flange 17a is in contact with the first insulating member 21a that is disposed on the front face of the sealing plate 13. Such a structure insulates the negative electrode terminal 17 from the sealing plate 13 with the first insulating member 21a and the second insulating member 21b interposed therebetween. The negative electrode collector 16 includes a flat attachment part 16a and an elongated main body 16b and has a cutout 16c at the boundary between the flat attachment part 16a and the main body 16b for easy bending. The main body 16b has a standing rib 16d on at least one side in the width direction.

Similarly, with respect to another mouth of the sealing plate 13, a first insulating member 22a composed of a gasket is disposed on a front face of the sealing plate 13, a second insulating member 22b is disposed on a back face of the sealing plate 13, and the positive electrode terminal 20 is inserted through the first insulating member 22a and the second insulating member 22b. The positive electrode terminal 20 has a flange 20a and is disposed so that the bottom face of the flange 20a is in contact with the first insulating member 22a that is disposed on the front face of the sealing plate 13. Such a structure insulates the positive electrode terminal 20 from the sealing plate 13 with the first insulating member 22a and the second insulating member 22b interposed therebetween. The positive electrode collector 18 includes a flat attachment part 18a and an elongated main body 18b and has a cutout 18c at the boundary between the flat attachment part 18a and the main body 18b for easy bending. The main body 18b has a standing rib 18d on at least one side in the width direction.

Each structure close to the negative electrode terminal 17 and the positive electrode terminal 20 will now be described. The negative electrode site has the same structure as that of the positive electrode site except that the collectors and the terminals are made of different materials and the structures are substantially symmetric. Therefore, the structure of the negative electrode site will be described below as a typical example and the structure of the positive electrode site may not be described in detail. The following constitution may be formed on at least one of the negative electrode site and the positive electrode site.

The second insulating member 21b in the negative electrode site has a plate-like shape and has a depression 21e on an opposite face to the sealing plate 13, thereby forming peripheral ribs 21c and 21d standing on the periphery of the second insulating member 21b. The depression 21e has a size capable of fitting the flat attachment part 16a of the negative electrode collector 16 without backlash. However, the peripheral ribs 21c and 21d have different widths or heights from each other. A pair of the peripheral ribs 21d along the width direction of the sealing plate 13 has at least one of a width and height larger than that of a pair of the peripheral ribs 21c along the longitudinal direction of the sealing plate 13. The peripheral rib 21c also has a cutout 21f at a portion at which the main body 16b of the negative electrode collector 16 is positioned.

The negative electrode collector 16 and the positive electrode collector 18 may be supplied with the respective ribs 16d and 18d bent but are commonly supplied as a flat plate. Thus, the first insulating member 21a is disposed on the front face of the sealing plate 13, and the negative electrode terminal 17 is inserted into the mouth of the sealing plate 13 to bring the flange 17a of the negative electrode terminal 17 into contact with the first insulating member 21a. In this state, the leading end of the negative electrode terminal 17 protruding through the back face of the sealing plate 13 is inserted through the hole of the second insulating member 21b and is further inserted through the hole of the flat attachment part 16a of the negative electrode collector 16. Then, the leading end of the negative electrode terminal 17 protruding through the back face of the sealing plate 13 is firmly crimped. This achieves the integral fixing of the negative electrode terminal 17 together with the first insulating member 21a, the second insulating member 21b, and the negative electrode collector 16 to the sealing plate 13 while maintaining the insulation and the air tightness between the negative electrode terminal 17 and the sealing plate 13. The boundary between the crimping part of the negative electrode terminal 17 and the flat attachment part 16a of the negative electrode collector 16 may be laser-welded in order to reduce the contact resistance between the negative electrode terminal 17 and the flat attachment part 16a.

The positive electrode site has the same structure as that of the negative electrode site. The positive electrode terminal 20 is integrally fixed together with the first insulating member 22a, the second insulating member 22b, and the positive electrode collector 18 to the sealing plate 13 while maintaining the insulation and the air tightness between the positive electrode terminal 20 and the sealing plate 13. The peripheral rib 21c of the second insulating member 21b in the negative electrode site has a cutout 21f at a position corresponding to the main body 16b of the negative electrode collector 16, while the peripheral rib 22c of the second insulating member 22b in the positive electrode site has a cutout 22f at a position corresponding to the main body 18b of the positive electrode collector 18. Thus, even when both the negative electrode collector 16 and the positive electrode collector 18 are a flat plate, the peripheral ribs 21c and 22c are not deformed. FIG. 2 shows this state.

Next, the negative electrode collector 16 is bent approximately 90 degrees at the boundary between the flat attachment part 16a and the main body 16b, and the positive electrode collector 18 is also bent approximately 90 degrees at the boundary between the flat attachment part 18a and the main body 18b. FIG. 4 and FIG. 5 show this state.

In the prismatic nonaqueous electrolyte secondary battery 10 of the embodiment, a pair of the peripheral ribs 21d that is formed in the second insulating member 21b and that is along the short sides of the sealing plate 13 has at least one of a width and height larger than that of a pair of the peripheral ribs 21c along the long sides of the sealing plate 13. Thus, even when a rotary force is applied to the negative electrode collector 16 at the time that the main body 16b of the negative electrode collector 16 is bent at a bending standard position as the boundary between the flat attachment part 16a and the main body 16b, the negative electrode collector 16 is easily and precisely bent because the flat attachment part 16a is held in the depression 21e of the second insulating member 21b in a stable condition. As a result, the main body 16b of the negative electrode collector 16 can be precisely bent with respect to the flat attachment part 16a, and this stabilizes the positional relation between the negative electrode collector 16 and the stacked negative electrode substrate exposed portion 14 of the flat electrode assembly 11. Such a relation is similarly achieved in the positive electrode site.

Therefore, with the prismatic nonaqueous electrolyte secondary battery 10 of the embodiment, the collector can be securely welded to the substrate exposed portion of the electrode assembly. In addition, the collector can be bent as designed and consequently the electrode assembly can be easily inserted into the prismatic hollow outer body. The embodiment has exemplified the prismatic nonaqueous electrolyte secondary battery 10 including the second insulating member 21b having the peripheral rib of which both of the two sides along the short sides of the sealing plate has at least one of a width and height larger than that of the other two sides along the long sides of the sealing plate. However, when at least one side closer to the bending part of the negative collector than the other side along the short sides has at least one of a width and height larger than that of the other two sides along the long sides, substantially the same advantages can be provided.

### Modification

The embodiment has exemplified the nonaqueous electrolyte secondary battery 10 including the following: The negative electrode collector 16 and the positive electrode collector 18 include the flat attachment parts 16a and 18a, respectively, each having an end from which the corresponding main body 16b or 18b extends. The negative electrode collector 16 and the positive electrode collector 18 are resistance-welded to the outermost faces of the stacked negative electrode substrate exposed portion 14 and the positive electrode substrate exposed portion 15 together with the negative electrode collector receiving member (not shown in the drawings) and the positive electrode collector receiving member 19, respectively. However, the negative electrode collector 16 and the positive electrode collector 18 may have pairs of the main bodies 16b and 18b formed from both ends of the flat attachment parts 16a and 18a in opposite directions to each other, respectively.

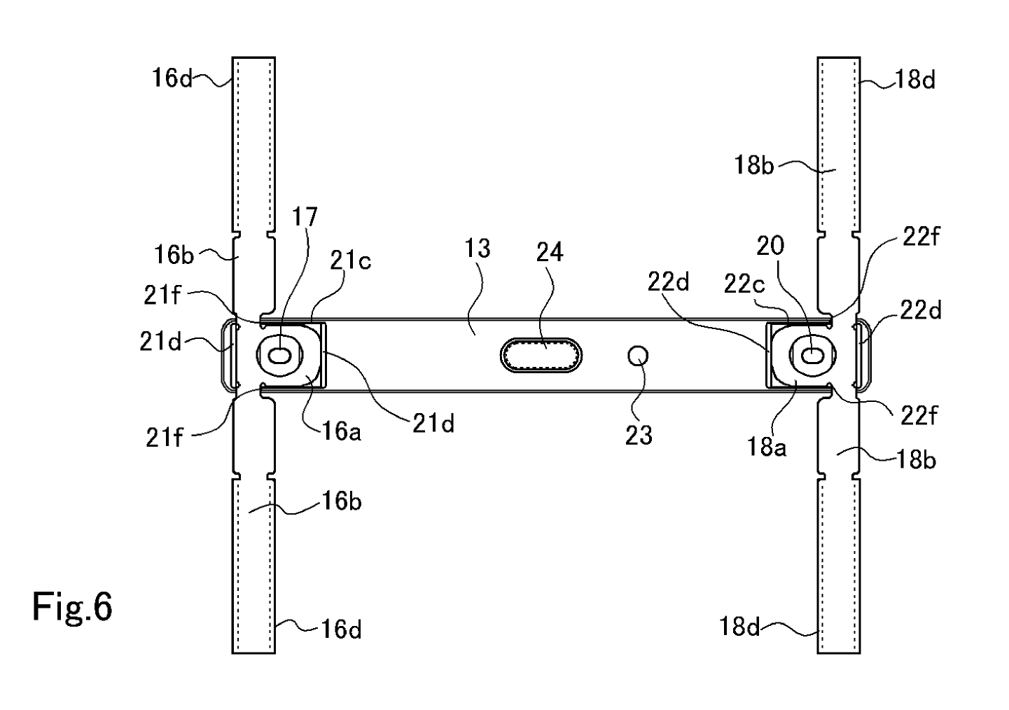

When the negative electrode collector 16 and the positive electrode collector 18 having such a structure of the modification are used, the negative electrode collector 16 and the positive electrode collector 18, each supplied as a flat plate, are fixed to the sealing plate to provide the structure as shown in FIG. 6. FIG. 6 is a plan view from the back face of the sealing plate 13 attached with the flat attachment parts 16a and 18a of the negative electrode collector 16 and the positive electrode collector 18 of the modification. In FIG. 6, the same components as those shown in the prismatic nonaqueous electrolyte secondary battery 10 of the embodiment are shown by the same reference characters and are not described in detail.

In the modification, the peripheral rib 21c formed in the second insulating member 21b in the negative electrode site has cutouts 21f at two positions, and the peripheral rib 22c formed in the second insulating member 22b in the positive electrode site also has cutouts 22f at two positions. Thus, even when both the negative electrode collector 16 and the positive electrode collector 18 of the modification, supplied as flat plates, are fixed to the sealing plate 13, the peripheral ribs 21c and 22c are not deformed. Moreover, both in the positive electrode site and the negative electrode site, the peripheral ribs 21d and 22d have at least one of a width and height larger than that of the peripheral ribs 21c and 22c, respectively, thereby easily bending the main body 16b of the negative electrode collector 16 and the main body 18b of the positive electrode collector 18. Thus, the main body 16b of the negative electrode collector 16 and the main body 18b of the positive electrode collector can be precisely bent with respect to the flat attachment parts 16a and 18a, respectively, thereby achieving good positional relations between the collectors 16 and 18 and the stacked substrate exposed portions 14 and 15 of the flat electrode assembly 11, respectively (see FIG. 1).

Therefore, even in this modification, the collectors 16 and 18 are securely welded to the substrate exposed portions 14 and 15 of the electrode assembly, respectively. The collectors 16 and 18 can be bent as designed and consequently the electrode assembly 11 can be easily inserted into the prismatic hollow outer body 12. In addition, when the collectors 16 and 18 have the pairs of the main bodies 16b and 18b formed from both ends of the flat attachment parts 16a and 18a in opposite directions to each other, electric current can be collected from both outermost faces on the stacked substrate exposed portion of the electrode assembly 11, thereby reducing internal resistance. As a result, a prismatic nonaqueous electrolyte secondary battery suitable for an application required to have a large size and large capacity can be obtained.

The connection method between the substrate exposed portion and the collector is not limited to resistance welding but the method may be, for example, ultrasonic welding or welding with a high energy beam.

1: A prismatic secondary battery comprising:
a prismatic hollow outer body having a mouth portion and a bottom;
a sealing plate having a first face and a second face, and sealing up the mouth portion;
an electrode assembly stored in the prismatic hollow outer body;
a collector electrically connected to the electrode assembly; and
a terminal electrically connected to the collector,
a first insulating member being disposed on the first face of the sealing plate,
a second insulating member being disposed on the second face of the sealing plate,
the sealing plate, the first insulating member, the second insulating member, and the collector all having through-holes,
the terminal being fixed to the sealing plate through the through-holes formed in the sealing plate, the first insulating member, the second insulating member, and the collector in a manner electrically insulated from the sealing plate,
the collector including a flat attachment part with an opening serving as the through-hole and a main body bent from an end of the flat attachment part and electrically connected to the electrode assembly,
the second insulating member being a plate member including a depression having a peripheral rib on an opposite face to the sealing plate,
the peripheral rib including two sides along short sides of the sealing plate, at least one side closer to the bending part of the collector than the other side along the short sides having at least one of a width and height larger than that of the other two sides along the long sides of the sealing plate, and
the flat attachment part of the collector being fitted to the depression.

2. The prismatic secondary battery according to claim 1, wherein the collector has a pair of main bodies formed from both ends of the flat attachment part in opposite directions to each other.

3. The prismatic secondary battery according to claim 1, wherein the terminal has a flange in a site of the first insulating member and also has a crimping part in a site of the second insulating member, the flange is disposed to be in contact with the first insulating member, and the crimping part connects the terminal to the flat attachment part of the collector and integrally fixes the sealing plate, the first insulating member, the second insulating member, and the collector.

4. The prismatic secondary battery according to claim 1, wherein the peripheral rib has a partial cutout in at least one side along the long sides of the sealing plate.

5. The prismatic secondary battery according to claim 1, wherein the collector has a cutout at the boundary between the flat attachment part and the main body where the collector has a smaller width than the width of the main body.

6. The prismatic secondary battery according to claim 2, wherein
the electrode assembly includes two ends opposite to each other, one end having a stacked substrate exposed portion of an electrode, and the other end having a stacked substrate exposed portion of a counter electrode,
the collector has the pair of main bodies formed from both ends of the flat attachment part in opposite directions to each other, and
the pair of the main bodies of the collector are connected to both outermost faces of at least one of the substrate exposed portions.

7. The prismatic secondary battery according to claim 6, wherein the main bodies of the collector are connected to the substrate exposed portion(s) by welding and the main bodies of the collector include a bent rib standing therefrom along a side facing the electrode assembly near the welding part.

8. The prismatic secondary battery according to claim 6, wherein at least one of the substrate exposed portions is divided into two portions, an intermediate member having at least one conductive member is disposed between the portions, the main body of the collector in a site of the bisectional substrate exposed portion is disposed on an outermost face of the bisectional substrate exposed portion, and the main body of the collector is resistance-welded to the substrate exposed portion.

9. The prismatic secondary battery according to claim 1, wherein
the electrode assembly includes two ends opposite to each other, one end having a stacked substrate exposed portion of an electrode, and the other end having a stacked substrate exposed portion of a counter electrode, and
the main body of the collector is connected to one outermost face of at least one of the substrate exposed portions, and a collector receiving member is connected to the other outermost face of at least one of the substrate exposed portions.

10. The prismatic secondary battery according to claim 9, wherein the main body of the collector and the collector receiving member are connected to the substrate exposed portions by welding, and both the main body of the collector and the collector receiving member include a bent rib standing therefrom along a side facing the electrode assembly near the welding part.

11. The prismatic secondary battery according to claim 9, wherein at least one of the substrate exposed portions is divided into two portions, an intermediate member having at least one conductive member is disposed between the portions, both the main body of the collector in a site of the bisectional substrate exposed portion and the collector receiving member are disposed on an outermost face of the bisectional substrate exposed portion, and both the main body of the collector and the collector receiving member may be resistance-welded to the substrate exposed portion.
